(19) United States
(12) Patent Application Publication
(10) Pub. No.: US 2025/0343000 A1
(43) Pub. Date: Nov. 6, 2025

(54) MULTILAYER COIL AND MULTILAYER COIL ARRAY

(71) Applicant: Murata Manufacturing Co., Ltd., Kyoto-fu (JP)

(72) Inventors: Takashi TOMOHIRO, Nagaokakyo-shi (JP); Yoshiko BANNO, Nagaokakyo-shi (JP)

(73) Assignee: Murata Manufacturing Co., Ltd., Kyoto-fu (JP)

(21) Appl. No.: 19/265,803

(22) Filed: Jul. 10, 2025

Related U.S. Application Data
(63) Continuation of application No. PCT/JP2023/030019, filed on Aug. 21, 2023.

(30) Foreign Application Priority Data
Jan. 30, 2023 (JP) 2023-012084

(51) Int. Cl. H01F 27/29; H01F 17/00; H01F 27/32

(52) U.S. Cl. CPC H01F 27/292; H01F 17/0013; H01F 27/324

(57) ABSTRACT

A multilayer coil and a multilayer coil array, each including a body in which a magnetic layer is laminated, a first coil including a plurality of first coil conductor layers in a lamination direction, and a second coil including a plurality of second coil conductor layers in the lamination direction. The first and second coils are inside the body, first and second external electrodes are electrically connected to the first coil, and third and fourth external electrodes are electrically connected to the second coil. The first to fourth external electrodes are on a bottom surface of the body, the second coil is at a position farther from the bottom surface of the body than the first coil is in the lamination direction, and the multilayer coil includes a first extended conductor inside the body and connecting an end of a first coil conductor layer closest to the bottom surface.

### CROSS-REFERENCE TO RELATED APPLICATIONS

This application claims benefit of priority to International Patent Application No. PCT/JP2023/030019, filed Aug. 21, 2023, and to Japanese Patent Application No. 2023-012084, filed Jan. 30, 2023, the entire contents of each are incorporated herein by reference.

### BACKGROUND

### Technical Field

The present disclosure relates to a multilayer coil and a multilayer coil array.

### Background Art

In recent years, the efficiency with a large current in DC-DC converters of voltage conversion circuits have been increasing because of high functionality of devices, and rated current of power inductors used in these devices has also been increasing. As a method for increasing the efficiency with a large current, a multiphase method of increasing the current by adding output currents from a plurality of inductors is being adopted. In this method, the output side of each inductor is electrically connected on the output circuit board of the inductor.

Japanese Patent Application Laid-Open No. 2020-61415 showing an example of the inductor discloses a multilayer coil array for a DC-DC converter, the multilayer coil array including a body including a magnetic layer containing magnetic grains, a first coil and a second coil built in the body, and a first external electrode, a second external electrode, a third external electrode, and a fourth external electrode provided on a surface of the body and each electrically connected to any one of ends of the first coil and the second coil. A non-magnetic layer is provided between the first coil and the second coil, a plurality of coil conductors are connected in a lamination direction in each of the first coil and the second coil, an end extended from a coil conductor closest to the second coil among the plurality of coil conductors of the first coil includes is connected to the first external electrode, and the other end of the first coil is connected to the second external electrode. Also, an end extended from a coil conductor closest to the first coil among the plurality of coil conductors of the second coil is connected to the third external electrode, the other end of the second coil is connected to the fourth external electrode, and the first external electrode and the third external electrode are connected to an output terminal of a switching element of the DC-DC converter.

### SUMMARY

In the process of mounting the coil array described in Japanese Patent Application Laid-Open No. 2020-61415 on an output circuit board or the like, an unexpected voltage due to static electricity or the like may be generated, and a large potential difference may be generated between the coils provided in the body. Then, because of the generation of a potential difference between the coils, a short circuit may occur in the vicinity where the coils are closest to each other, the insulation resistance between the coils may lower, and the electrical characteristics of the coils may degrade.

Accordingly, the present disclosure provides a multilayer coil and a multilayer coil array that reduce degradation of the electrical characteristics.

A multilayer coil of the present disclosure includes a body in which a magnetic layer is laminated; a first coil including a plurality of first coil conductor layers in a lamination directio n, and a second coil including a plurality of second coil conductor layers in the lamination direction, the first coil and the second coil being provided inside the body; a first external electrode electrically connected to the first coil and a second external electrode electrically connected to the first coil; and a third external electrode electrically connected to the second coil and a fourth external electrode electrically connected to the second coil. The first to fourth external electrodes are disposed on a bottom surface of the body, and the second coil is provided at a position farther from the bottom surface of the body than the first coil is in the lamination direction. The multilayer coil includes a first extended conductor provided inside the body and connecting an end of a first coil conductor layer closest to the bottom surface among the plurality of first coil conductor layers out of ends of the first coil and the first external electrode; a second extended conductor provided inside the body and connecting the other end of the first coil and the second external electrode; a third extended conductor provided inside the body and connecting an end of a second coil conductor layer closest to the bottom surface among the plurality of second coil conductor layers out of ends of the second coil and the third external electrode; and a fourth extended conductor provided inside the body and connecting the other end of the second coil and the fourth external electrode. The second external electrode and the third external electrode are electrically connected.

A multilayer coil array of the present disclosure includes a body in which a magnetic layer is laminated; a first coil including a plurality of first coil conductor layers in a lamination direction, and a second coil including a plurality of second coil conductor layers in the lamination direction, a third coil including a plurality of third coil conductor layers in the lamination direction, and a fourth coil including a plurality of fourth coil conductor layers in the lamination direction, the first coil, the second coil, the third coil, and the fourth coil being provided inside the body. The multilayer coil array further includes a first external electrode electrically connected to the first coil and a second external electrode electrically connected to the first coil; a third external electrode electrically connected to the second coil and a fourth external electrode electrically connected to the second coil; a fifth external electrode electrically connected to the third coil and a sixth external electrode electrically connected to the third coil; and a seventh external electrode electrically connected to the fourth coil and an eighth external electrode electrically connected to the fourth coil. The first to eighth external electrodes are disposed on a bottom surface of the body, the second coil is provided at a position farther from the bottom surface of the body than the first coil is in the lamination direction, and the fourth coil is provided at a position farther from the bottom surface of the body than the third coil is in the lamination direction. The multilayer coil includes a first extended conductor provided inside the body and connecting an end of a first coil conductor layer closest to the bottom surface among the plurality of first coil conductor layers out of ends of the first coil and the first external electrode; a second extended conductor provided inside the body and connecting the other end of the first coil and the second external electrode; a third extended conductor provided inside the body and connecting an end of a second coil conductor layer closest to the bottom surface among the plurality of second coil conductor layers out of ends of the second coil and the third external electrode; and a fourth extended conductor provided inside the body and connecting the other end of the second coil and the fourth external electrode. The multilayer coil further includes a fifth extended conductor provided inside the body and connecting an end of a third coil conductor layer closest to the bottom surface among the plurality of third coil conductor layers out of ends of the third coil and the fifth external electrode; a sixth extended conductor provided inside the body and connecting the other end of the third coil and the sixth external electrode; a seventh extended conductor provided inside the body and connecting an end of a fourth coil conductor layer closest to the bottom surface among the plurality of fourth coil conductor layers out of ends of the fourth coil and the seventh external electrode; and an eighth extended conductor provided inside the body and connecting the other end of the fourth coil and the eighth external electrode. The second external electrode and the third external electrode are electrically connected, and the sixth external electrode and the seventh external electrode are electrically connected.

The present disclosure can provide a multilayer coil and a multilayer coil array that reduce degradation of the electrical characteristics. Specifically, since the second external electrode and the third external electrode are directly connected, a short circuit can be prevented between the coils in the body when an unexpected voltage is generated in the multilayer coil or the like, and a situation in which the insulation resistance between the coils lowers can be reduced. Thus, degradation of the electrical characteristics of the multilayer coil or the like can be reduced.

### BRIEF DESCRIPTION OF THE DRAWINGS

FIG. 1 is a perspective view schematically illustrating an example of a multilayer coil according to a first embodiment;

FIG. 2 is a perspective view schematically illustrating an example of an internal structure of the multilayer coil of the first embodiment;

FIG. 3 is a perspective view in which a first coil, a first extended conductor, and a second extended conductor are extracted from the internal structure illustrated in FIG. 2;

FIG. 4 is a perspective view in which a second coil, a third extended conductor, and a fourth extended conductor are extracted from the internal structure illustrated in FIG. 2;

FIG. 5 is an exploded perspective view of the internal structure illustrated in FIG. 2;

FIG. 6 is a sectional view taken along the line VI-VI in FIG. 5 as seen from the direction of the arrows;

FIG. 7 is a perspective view schematically illustrating an example of an internal structure according to a modification of the first embodiment;

FIG. 8A is a perspective view (top view) schematically illustrating an example of an internal structure of a multilayer coil of a second embodiment;

FIG. 8B is a perspective view (bottom view) schematically illustrating an example of the internal structure of the multilayer coil of the second embodiment;

FIG. 9 is an exploded perspective view of a part of the internal structure of the multilayer coil of the second embodiment;

FIG. 10 is a perspective view (top view) schematically illustrating an example of an internal structure of a multilayer coil of a third embodiment;

FIG. 11 is an exploded perspective view of a part of the internal structure of the multilayer coil of the third embodiment;

FIG. 12A is a perspective view schematically illustrating an example of an internal structure of a multilayer coil array of the present disclosure;

FIG. 12B is a perspective view schematically illustrating an example of the internal structure of the multilayer coil array of the present disclosure; and

FIG. 12C is a perspective view schematically illustrating an example of the internal structure of the multilayer coil array of the present disclosure.

### DETAILED DESCRIPTION

Hereinafter, a multilayer coil and a multilayer coil array of the present disclosure will be described. The present disclosure is not limited to the following configurations, and may be appropriately changed without departing from the gist of the present disclosure. The present disclosure also includes a combination of a plurality of preferable configurations described below.

The multilayer coil and the multilayer coil array of the present disclosure are used, for example, in a DC-DC converter. The multilayer coil and the multilayer coil array of the present disclosure are also applicable to applications other than a DC-DC converter.

In the present specification, the terms (for example, “parallel” and “orthogonal”) indicating a relationship between elements and the terms indicating a shape of an element not only mean only a strictly literal aspect, but also mean a range including a substantially equivalent range, for example, a difference of about several %. In the present specification, a direction in which a magnetic layer and a conductor layer constituting a body are laminated is referred to as “lamination direction”.

The drawings described below are schematic views, and dimensions, scales of aspect ratios, and the like may be different from those of actual products.

### First Embodiment of Multilayer Coil

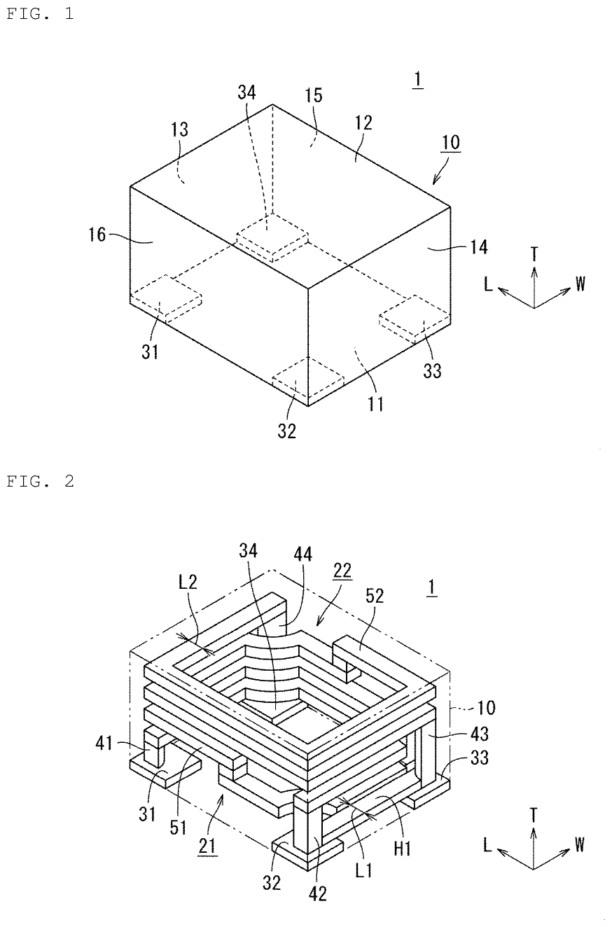

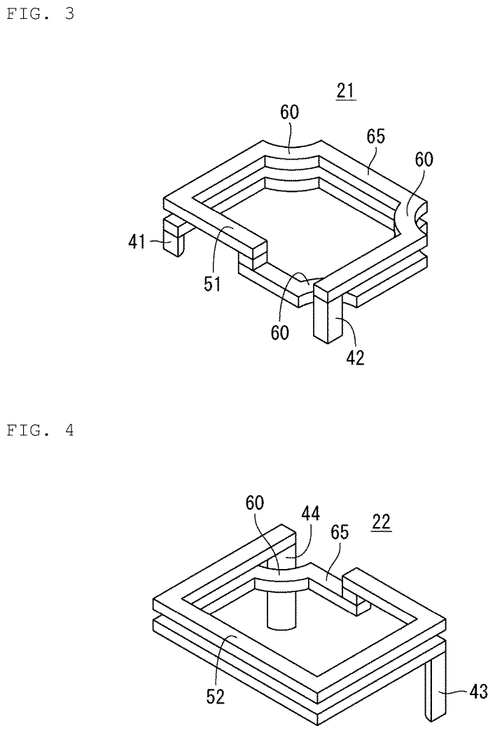

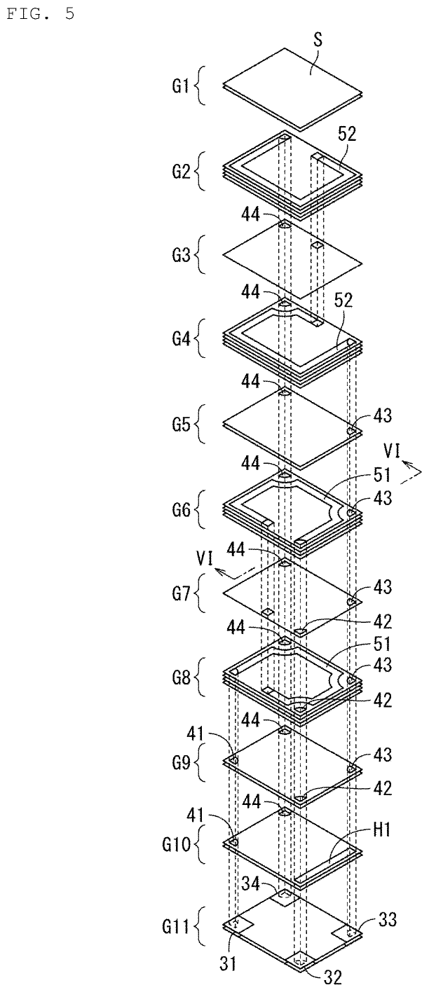

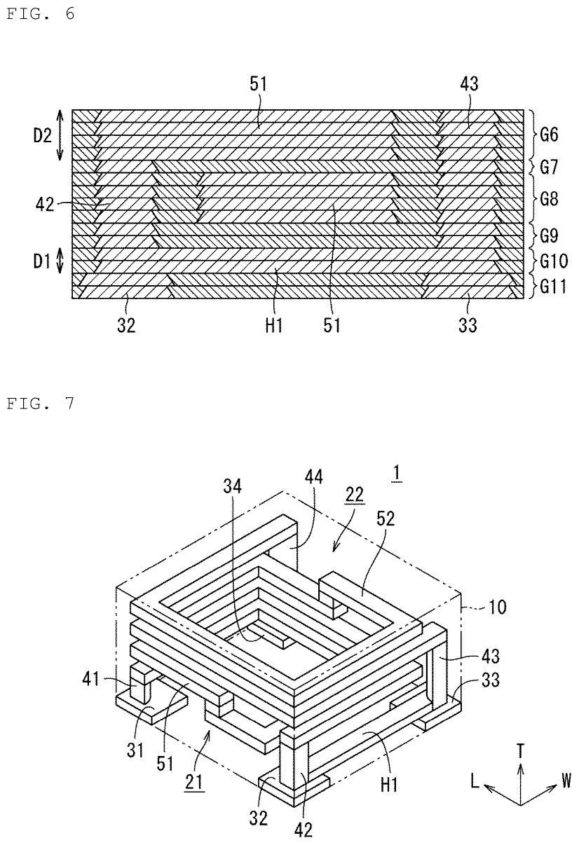

First, a multilayer coil according to a first embodiment of the present disclosure will be described with reference to FIGS. 1 to 6. FIG. 1 is a perspective view schematically illustrating an example of a multilayer coil of the first embodiment, FIG. 2 is a perspective view schematically illustrating an example of an internal structure of the multilayer coil of the first embodiment, FIG. 3 is a perspective view in which a first coil, a first extended conductor, and a second extended conductor are extracted from the internal structure illustrated in FIG. 2, FIG. 4 is a perspective view in which a second coil, a third extended conductor, and a fourth extended conductor are extracted from the internal structure illustrated in FIG. 2, FIG. 5 is an exploded perspective view of the internal structure illustrated in FIG. 2, and FIG. 6 is a sectional view taken along the line IV-IV in FIG. 5 as seen from the direction of the arrows. The shape, disposition, and the like of the multilayer coil and each component are not limited to the illustrated examples.

A multilayer coil 1 illustrated in FIGS. 1 and 2 includes a body 10, a first coil 21, a second coil 22, a first external electrode 31, a second external electrode 32, a third external electrode 33, a fourth external electrode 34, a first extended conductor 41, a second extended conductor 42, a third extended conductor 43, and a fourth extended conductor 44. Hereinafter, each component will be described in detail.

### -Body-

The body 10 has, for example, a rectangular parallelepiped shape or a substantially rectangular parallelepiped shape having six surfaces. The body 10 may have rounded corner portions and rounded ridge portions. The corner portion is a portion where three surfaces of the body 10 intersect, and the ridge portion is a portion where two surfaces of the body 10 intersect.

In FIGS. 1 and 2, a length direction, a width direction, and a height direction of the multilayer coil 1 and the body 10 are indicated as an L direction, a W direction, and a T direction, respectively. The length direction L, the width direction W, and the height direction T are orthogonal to each other. The mounting surface of the multilayer coil 1 is, for example, a surface (LW surface) parallel to the length direction L and the width direction W.

The body 10 illustrated in FIG. 1 includes a first main surface 11 and a second main surface 12 facing each other in the height direction T, a first end surface 13 and a second end surface 14 facing each other in the length direction L orthogonal to the height direction T, and a first side surface 15 and a second side surface 16 facing each other in the width direction W orthogonal to the length direction L and the height direction T. In the example illustrated in FIG. 1, the first main surface 11 of the body 10 corresponds to the bottom surface of the body 10.

The body 10 includes a magnetic layer S (see FIG. 5). The body 10 preferably has a multilayer structure. Specifically, the body 10 preferably includes a plurality of magnetic layers S in a lamination direction (for example, the height direction T). In the present embodiment, as illustrated in FIG. 5, magnetic layer groups G1 to G11 including at least one magnetic layer S may be laminated. The boundary of each layer of the multilayer structure of the body 10 does not have to appear clearly.

The magnetic layer group G1 includes two magnetic layers S as an example, and constitutes the second main surface 12 of the body 10.

The magnetic layer group G2 includes four magnetic layers S as an example. The magnetic layer S is provided with a second coil conductor layer 52, and these four second coil conductor layers 52 constitute one winding of the second coil 22.

The magnetic layer group G3 includes one magnetic layer S as an example. The magnetic layer S is provided with a conductor layer (via conductor) for connecting the second coil conductor layers 52 of the magnetic layer group G2 and the second coil conductor layers 52 of the magnetic layer group G4, and a fourth extended conductor 44 for electrically connecting the second coil conductor layers 52 and the fourth external electrode 34.

The magnetic layer group G4 includes four magnetic layers S as an example. The magnetic layer S is provided with a second coil conductor layer 52, and these four second coil conductor layers 52 constitute another winding of the second coil 22. A fourth extended conductor 44 is provided at a corner portion of the magnetic layer group G4.

The magnetic layer group G5 includes two magnetic layers S as an example. The magnetic layer S is provided with the third extended conductor 43 for electrically connecting the second coil conductor layers 52 and the third external electrode 33, and the fourth extended conductor 44 for electrically connecting the second coil conductor layers 52 and the fourth external electrode 34.

The magnetic layer group G6 includes four magnetic layers S as an example. The magnetic layer S is provided with a first coil conductor layer 51, and these four first coil conductor layers 51 constitute one winding of the first coil 21. In the magnetic layer group G6, the fourth extended conductor 44 and the third extended conductor 43 described above are provided at a corner portion on one side of each magnetic layer S.

The magnetic layer group G7 includes one magnetic layer S as an example. The magnetic layer S is provided with a conductor layer (via conductor) for connecting the first coil conductor layers 51 of the magnetic layer group G6 and the first coil conductor layers 51 of the magnetic layer group G8, and the second extended conductor 42 for electrically connecting the first coil conductor layers 51 and the second external electrode 32. In the magnetic layer group G7, the fourth extended conductor 44 and the third extended conductor 43 described above are provided at a corner portion on one side of each magnetic layer S.

The magnetic layer group G8 includes four magnetic layers S as an example. The magnetic layer S is provided with the first coil conductor layer 51, and these four first coil conductor layers 51 constitute another winding of the first coil 21. In the magnetic layer group G8, the fourth extended conductor 44 and the third extended conductor 43 described above are provided at a corner portion on one side of each magnetic layer S. Further, the second extended conductor 42 is provided at a corner portion on the other side of S of each magnetic layer.

The magnetic layer group G9 includes two magnetic layers S as an example. The magnetic layer S is provided with the first extended conductor 41, the second extended conductor 42, the third extended conductor 43, and the fourth extended conductor 44 at corner portions.

The magnetic layer group G10 includes two magnetic layers S as an example. The magnetic layer S is provided with the first extended conductor 41 and the fourth extended conductor 44, and a conductor wiring H1 for directly connecting the second external electrode 32 and the third external electrode 33.

The magnetic layer group G11 includes two magnetic layers S as an example. The magnetic layer S is provided with the first external electrode 31, the second external electrode 32, the third external electrode 33, and the fourth external electrode 34.

When the body 10 has a multilayer structure, the degree of freedom in designing the multilayer coil 1 increases. For example, when the multilayer coil 1 including the first external electrode 31, the second external electrode 32, the third external electrode 33, and the fourth external electrode 34 on the bottom surface (first main surface 11) of the body 10 is produced, the first coil 21 and the second coil 22 can be easily extended to the bottom surface side.

The magnetic layer S includes magnetic grains made of a magnetic material. The magnetic grains may be grains of a metal magnetic material such as Fe, Co, Ni, and an alloy containing at least one of these (metal magnetic grains), or ferrite grains. The magnetic grains are preferably Fe grains or Fe alloy grains. The Fe alloy is preferably an Fe—Si-based alloy, an Fe—Si—Cr-based alloy, an Fe—Si—Al-based alloy, an Fe—Si—B—P—Cu—C-based alloy, an Fe—Si—B—Nb—Cu-based alloy, or the like.

The surface of the metal magnetic grains made of the above-described metal magnetic material is preferably covered with an insulating film. When the surface of the metal magnetic grains is covered with an insulating film, the insulating property between the metal magnetic grains can be enhanced. As a method for forming an insulating film on the surface of the metal magnetic grains, a sol-gel method, a mechanochemical method, or the like can be used. The material constituting the insulating film is preferably an oxide of P, Si, or the like. The insulating film may be an oxide film formed by oxidizing the surface of the metal magnetic grains. The thickness of the insulating film is preferably 1 nm or more and 50 nm or less (i.e., from 1 nm to 50 nm), more preferably 1 nm or more and 30 nm or less (i.e., from 1 nm to 30 nm), and still more preferably 1 nm or more and 20 nm or less (i.e., from 1 nm to 20 nm). For example, a section obtained by polishing a sample of the multilayer coil array is photographed with a scanning electron microscope (SEM), and the thickness of the insulating film covering the surface of the metal magnetic grains can be measured from the obtained SEM photograph.

The average grain size of the metal magnetic grains in the magnetic layer S is preferably 1 μm or more and 30 μm or less (i.e., from 1 μm to 30 μm), more preferably 1 μm or more and 20 μm or less (i.e., from 1 μm to 20 μm), and still more preferably 1 μm or more and 10 μm or less (i.e., from 1 μm to 10 μm). The average grain size of the metal magnetic grains in the magnetic layer can be measured by the procedure described below. For a section obtained by cutting a sample of the multilayer coil, regions (for example, 130 μm×100 μm) at a plurality of points (for example, 5 points) are photographed by an SEM, and the obtained SEM image is analyzed using image analysis software (for example, image analysis software WinROOF2021 (manufactured by MITANI CORPORATION)) to determine the equivalent circle diameter of the metal magnetic grains. The average value of the obtained equivalent circle diameters is taken as the average grain size of the metal magnetic grains.

When the body 10 is formed, heat treatment is performed. In this case, the metal magnetic grains contained in the body 10 each have an oxide film on the surface. This oxide film is derived from metal magnetic grains and is formed through heat treatment. In the body 10, adjacent metal magnetic grains are joined to each other with the oxide film interposed therebetween.

The body 10 may include a non-magnetic layer between the first coil 21 and the second coil 22. By providing a non-magnetic layer between the first coil 21 and the second coil 22, insulation between the first coil 21 and the second coil 22 can be enhanced, and a short circuit between the coils can be prevented.

The non-magnetic layer may contain a glass ceramic material, a non-magnetic ferrite material, and the like as the non-magnetic material. The non-magnetic layer preferably contains a non-magnetic ferrite material as the non-magnetic material. As the non-magnetic ferrite material, a non-magnetic ferrite material having a composition in which Fe is 40 mol % or more and 49.5 mol % or less (i.e., from 40 mol % to 49.5 mol %) in terms of Fe₂O₃, Cu is 6 mol % or more and 12 mol % or less (i.e., from 6 mol % to 12 mol %) in terms of CuO, and the balance is ZnO can be used. The non-magnetic material may contain Mn₃O₄, Co₃O₄, SnO₂, Bi₂O₃, SiO₂, and the like as additives as necessary, and may contain a trace amount of inevitable impurities. The non-magnetic layer preferably contains Zn—Cu-based ferrite.

The thickness of the non-magnetic layer can be measured by the procedure described below. Vertically place a sample of the multilayer coil, and put resin around the sample to fix the sample. At this time, expose the LT surface. Finish polishing at a depth of about ½ in the W direction of the sample with a polishing machine to expose a section parallel to the LT plane. To remove sagging of the internal conductor due to polishing, after completion of polishing, process the polished surface with an ion milling (ion milling apparatus IM4000 manufactured by Hitachi High-Tech Corporation). Photograph the substantially central portion of the non-magnetic layer in the polished sample with an SEM, and measure the thickness of the substantially central portion of the non-magnetic layer from the obtained SEM photograph, which is defined as the thickness of the non-magnetic layer.

The body 10 may include a non-magnetic portion between the plurality of first coil conductor layers 51 constituting the first coil 21 or between the plurality of second coil conductor layers 52 constituting the second coil 22. In such a case, the non-magnetic portion is provided at least at one position between adjacent coil conductor layers in the first coil conductor layer 51 and the second coil conductor layer 52. By providing the non-magnetic portion between adjacent coil conductor layers, leakage of the magnetic flux between the coil conductor layers can be prevented.

The non-magnetic layer and the non-magnetic portion preferably have the same composition. For example, the non-magnetic layer and the non-magnetic portion are preferably made of Zn—Cu ferrite.

The first coil 21 and the second coil 22 are provided inside the body 10. The first coil 21 and the second coil 22 are preferably magnetically coupled. One end of the first coil 21 and one end of the second coil 22 may be electrically connected as described later. Two coils including only the first coil 21 and the second coil 22 may be provided inside the body 10, or three or more coils including the first coil 21 and the second coil 22 may be provided.

### -First Coil-

The first coil 21 includes a plurality of first coil conductor layers 51 in a lamination direction (for example, the height direction T). Adjacent first coil conductor layers 51 are connected to each other via a via conductor. The number of windings of the first coil 21 may be set to 1.75 by including the first coil conductor layers 51 formed in two different magnetic layer groups in the lamination direction (see FIG. 3). The number of windings is not limited to 1.75 as the illustrated example, and may be, for example, 2 or more by laminating the first coil conductor layer 51 in the lamination direction.

The thicknesses of the first coil conductor layers 51 are preferably the same. The thickness of the first coil conductor layer 51 is preferably equal to the thickness of the second coil conductor layer 52 described later.

The first coil conductor layer 51 may be a metal conductor such as Ag, Cu, and/or Pd as an example of the material. The first coil conductor layer 51 may be formed by, for example, applying a conductive paste on the above-described magnetic layer S.

FIG. 3 is a perspective view of the first coil 21, the first extended conductor 41, and the second extended conductor 42 extracted from the internal structure illustrated in FIG. 2.

To avoid the second extended conductor 42, the third extended conductor 43, and the fourth extended conductor 44, the first coil conductor layer 51 may include an avoidance portion 60 disposed inside each of the second extended conductor 42, the third extended conductor 43, and the fourth extended conductor 44 in plan view as seen from a lamination direction (for example, the height direction T), and a straight portion 65 connected to the avoidance portion 60. By providing the avoidance portion 60, the outer shape of the first coil can be increased to enhance the characteristics of the coil, and the interference of the second extended conductor 42, the third extended conductor 43, and the fourth extended conductor 44 with the first coil conductor layer 51 can be reduced to appropriately extend the wiring from the first coil 21 toward the external electrodes.

The avoidance portion 60 of the first coil conductor layer 51 is not limited as long as it is disposed inside the second extended conductor 42 in plan view as seen from a lamination direction (for example, the height direction T) to avoid at least the second extended conductor 42. That is, as long as the first coil conductor layer 51 includes the avoidance portion 60 for avoiding at least the second extended conductor 42, the avoidance portion 60 for avoiding at least one of the third extended conductor 43 and the fourth extended conductor 44 does not have to be included.

### -Second Coil-

The second coil 22 is provided at a position farther from the bottom surface (first main surface 11) of the body 10 than the first coil 21.

The second coil 22 includes a plurality of second coil conductor layers 52 in a lamination direction (for example, the height direction T). Adjacent second coil conductor layers 52 are connected to each other via a via conductor. The number of windings of the second coil 22 may be set to 1.75 by including the second coil conductor layers 52 formed in two different magnetic layer groups in the lamination direction (see FIG. 4). The number of windings is not limited to 1.75 as the illustrated example, and may be, for example, 2 or more by laminating the first coil conductor layer 51 in the lamination direction. The number of laminations of the second coil conductor layers 52 may be the same as or different from the number of laminations of the first coil conductor layers 51.

The thicknesses of the second coil conductor layers 52 are preferably the same. The thickness of the second coil conductor layer 52 is preferably equal to the thickness of the first coil conductor layer 51.

The second coil conductor layer 52 may be a metal conductor such as Ag, Cu, and/or Pd as an example of the material. As the material of the second coil conductor layer 52, the same type of material as that of the first coil conductor layer 51 may be used, or different types of materials may be used. The second coil conductor layer 52 may be formed by, for example, applying a conductive paste on the above-described magnetic layer S.

FIG. 4 is a perspective view of the second coil 22, the third extended conductor 43, and the fourth extended conductor 44 extracted from the internal structure illustrated in FIG. 2.

As illustrated in FIG. 4, the second coil conductor layer 52 may include the avoidance portion 60 disposed inside each fourth extended conductor 44 in plan view as seen from a lamination direction (for example, the height direction T) to avoid the fourth extended conductor 44, and the straight portion 65 connected to the avoidance portion 60. By providing the avoidance portion 60, the outer shape of the second coil can be increased to enhance the characteristics of the coil, and the interference with the fourth extended conductor 44 can be reduced to appropriately extend the wiring from the second coil 22 toward the external electrodes.

### -External Electrode-

The external electrodes include the first external electrode 31, the second external electrode 32, the third external electrode 33, and the fourth external electrode 34. The first external electrode 31 and the second external electrode 32 are provided on the bottom surface (first main surface 11) of the body 10, and are electrically connected to the first coil 21. The third external electrode 33 and the fourth external electrode 34 are provided on the bottom surface (first main surface 11) of the body 10, and are electrically connected to the second coil 22. In the multilayer coil 1, the bottom surface (first main surface 11) of the body 10 can be a mounting surface. That is, mounting can be performed on the bottom surface of the multilayer coil 1.

The first external electrode 31 acts as an input electrode with respect to the first coil 21. The first external electrode 31 may be provided only on the first main surface 11 of the body 10, or may be provided across the first main surface 11 of the body 10 and at least one of the first end surface 13 and the second side surface 16.

The second external electrode 32 acts as an output electrode with respect to the first coil 21. The second external electrode 32 may be provided only on the first main surface 11 of the body 10, or may be provided across the first main surface 11 of the body 10 and at least one of the second end surface 14 and the second side surface 16.

The third external electrode 33 acts as an output electrode with respect to the second coil 22. The third external electrode 33 may be provided only on the first main surface 11 of the body 10, or may be provided across the first main surface 11 of the body 10 and at least one of the second end surface 14 and the first side surface 15.

The fourth external electrode 34 acts as an input electrode with respect to the second coil 22. The fourth external electrode 34 may be provided only on the first main surface 11 of the body 10, or may be provided across the first main surface 11 of the body 10 and at least one of the first end surface 13 and the first side surface 15.

Since the external electrodes are configured as described above, when a current is supplied from the first external electrode 31 in the multilayer coil 1, the current flows through the first coil 21 clockwise as the first coil 21 illustrated in the perspective view in FIG. 2 is viewed in plan view. When a current is supplied from the fourth external electrode 34, the current flows through the second coil 22 counterclockwise as the second coil 22 illustrated in the perspective view of FIG. 2 is viewed in plan view. That is, the direction of the current flowing through the first coil 21 and the direction of the current flowing through the second coil 22 are opposite to each other. In other words, the winding direction of the first coil 21 and the winding direction of the second coil 22 are opposite to each other as viewed from the output-side electrodes (the second external electrode 32 and the third external electrode 33). Thus, at the central axis of the first coil 21, a magnetic flux is generated from the top surface toward the bottom surface, and in the second coil 22, a magnetic flux is generated from the bottom surface toward the top surface. Therefore, the coils are wound in such a manner as to cancel the magnetic flux of the first coil 21 and the magnetic flux of the second coil 22 each other. As a result, optimum characteristics as an inductor used for a multiphase DC-DC converter can be obtained.

In the multilayer coil 1 of the present disclosure, the second external electrode 32 and the third external electrode 33 are directly connected. More specifically, in the multilayer coil 1 of the first embodiment, the second extended conductor 42 and the third extended conductor 43 described later are directly connected. By causing the output-side end of the first coil 21 and the output-side end of the second coil 22 to directly conduct to each other in this manner, generation of a potential difference between the coils before the coils are mounted on a board is reduced. Thus, it is possible to reduce degradation of the electrical characteristics of the inductor due to an occurrence of a short circuit between the coils provided in the body 10 caused by an occurrence of an unexpected voltage in the multilayer coil before the coils are mounted on a board.

As a suitable disposition of the external electrodes, the second external electrode 32 and the third external electrode 33 constituting the output electrodes of the multilayer coil 1 are disposed along one side constituting the outer edge of the body 10. In other words, the second external electrode 32 and the third external electrode 33 are not disposed along a diagonal line of the body 10 in plan view. By disposing the external electrodes in this manner, the output electrode and the input electrode can be aligned on the same side surface of the body, and the wiring on the board to the multilayer coil 1 can be simplified.

Each of the first external electrode 31, the second external electrode 32, the third external electrode 33, and the fourth external electrode 34 may be made of a conductive material such as Ag, Cu, and/or Pd. More preferably, a plating layer of one or more materials selected from Ni, Sn, Cu, and Au may be provided on the surfaces of these external electrodes. By providing a plating layer of the above material, the external electrodes can be appropriately mounted on the mounting board.

The thicknesses of the first external electrode 31, the second external electrode 32, the third external electrode 33, and the fourth external electrode 34 are each preferably 5 μm or more and 100 μm or less (i.e., from 5 μm to 100 μm), and more preferably 10 μm or more and 50 μm or less (i.e., from 10 μm to 50 μm).

The thickness of the external electrodes such as the first external electrode 31 can be measured by the procedure described for “the thickness of the non-magnetic layer”. That is, polish a sample by the above-described method, and photograph the portion of the external electrode with an SEM. In the obtained SEM photograph, measure a substantially central portion of the external electrode at one point, which is defined as the thickness of the external electrode.

### -Extended Conductor-

The extended conductors include the first extended conductor 41, the second extended conductor 42, the third extended conductor 43, and the fourth extended conductor 44. The first extended conductor 41, the second extended conductor 42, the third extended conductor 43, and the fourth extended conductor 44 are provided inside the body 10.

The first extended conductor 41 connects the end of the first coil conductor layer 51 closest to the bottom surface (first main surface 11) of the body 10 out of the ends of the first coil 21 and the first external electrode 31. The first extended conductor 41 preferably extends along a lamination direction (for example, the height direction T). The first extended conductor 41 may have a multilayer structure.

The second extended conductor 42 connects the other end of the first coil 21 and the second external electrode 32. The second extended conductor 42 preferably extends along a lamination direction (for example, the height direction T). The second extended conductor 42 may have a multilayer structure.

The third extended conductor 43 connects the end of the second coil conductor layer 52 closest to the bottom surface (first main surface 11) of the body 10 out of the ends of the second coil 22 and the third external electrode 33. The third extended conductor 43 preferably extends along a lamination direction (for example, the height direction T). The third extended conductor 43 may have a multilayer structure.

The fourth extended conductor 44 connects the other end of the second coil 22 and the fourth external electrode 34. The fourth extended conductor 44 preferably extends along a lamination direction (for example, the height direction T). The fourth extended conductor 44 may have a multilayer structure.

As described above, the second extended conductor 42 and the third extended conductor 43 are directly connected by the conductor wiring H1. Thus, it is possible to reduce a situation in which the insulation resistance between coils provided in the body 10 decreases by preventing a short circuit between the coils caused by an occurrence of an unexpected voltage in the multilayer coil. Thus, degradation of electrical characteristics of the inductor can be reduced.

Similarly to the first coil conductor layer 51, the second coil conductor layer 52, and the external electrode, the material of the conductor wiring H1 may be made of a conductive material such as Ag, Cu, and/or Pd. As the conductor wiring H1, the same type of material as the first coil conductor layer 51, the second coil conductor layer 52, and the external electrode may be used, or different types of materials may be used.

The size of the conductor wiring H1 may be a size capable of directly connecting the second extended conductor 42 and the third extended conductor 43. For example, the size of the conductor wiring H1 is a size with which the conductive paste constituting the conductor wiring H1 can be easily applied, and the thickness in the lamination direction is preferably 10 μm or more and 100 μm or less (i.e., from 10 μm to 100 μm), and the width dimension orthogonal to the lamination direction is preferably 50 μm or more and 300 μm or less (i.e., from 50 μm to 300 μm). In other words, the thickness of the conductor wiring H1 is preferably equal to or less than the width of the conductor wiring H1. The “width dimension” in the present specification means a width dimension at a position where the width dimension is the widest in a section parallel to the LT plane similar to the thickness measurement of the non-magnetic layer, in consideration of variations in the width dimension depending on the position.

Further, a thickness D1 of the conductor wiring H1 is preferably equal to or less than a thickness D2 of a portion constituting one winding in the first coil 21 (or the second coil 22) (see FIG. 6). A width dimension L1 of the conductor wiring H1 is preferably equal to or smaller than a width dimension L2 of the portion constituting one winding in the first coil 21 (or the second coil 22) (see FIG. 2). With such a size of the conductor wiring H1, the interference of the magnetic flux of the first coil 21 and the second coil 22 can be reduced, and the second extended conductor 42 and the third extended conductor 43 can be appropriately and directly connected. In addition, as one of the reasons for designing the thickness of the conductor wiring H1 as described above, a large current flows in the first coil 21 or the second coil 22 at the time of operation as a DC-DC converter, and thus a low resistance is required, whereas a current hardly flows through the conductor wiring H1 because the conductor wiring H1 is mainly intended to reduce a potential difference due to static electricity before the coils are mounted. With this configuration, degradation of the characteristics of the multilayer coil can be reduced.

Here, as a suitable disposition of the first extended conductor 41 to the fourth extended conductor 44, the second extended conductor 42 and the third extended conductor 43 electrically connected to the output electrode of the multilayer coil 1 are disposed along one side constituting the outer edge of the body 10. In other words, the second extended conductor 42 and the third extended conductor 43 are not disposed along a diagonal line of the body 10 in plan view. By disposing the extended conductors in this manner, the output electrodes and the input electrodes can be aligned in the same direction.

### Modification of First Embodiment of Multilayer Coil

Next, a multilayer coil according to a modification of the first embodiment will be described with reference to FIG. 7. FIG. 7 is a perspective view schematically illustrating an example of an internal structure according to the modification of the first embodiment. The present modification is different from the multilayer coil of the first embodiment described above in that the avoidance portion 60 is not provided in the coil conductor layer. In the following description, differences from the multilayer coil described in the first embodiment will be mainly described.

### -First Coil-

In the present modification, the first coil conductor layer 51 of the first coil 21 is wound so as not to overlap the third external electrode 33 or the fourth external electrode 34 in plan view. In other words, the first coil conductor layer 51 of the first coil 21 is wound to be separated from the third extended conductor 43 and the fourth extended conductor 44 in plan view.

### -Second Coil-

In the present modification, the third extended conductor 43 and the fourth extended conductor 44 electrically connected to an end of the second coil 22 are disposed outside the first coil conductor layer 51 of the first coil 21. That is, the third extended conductor 43 and the fourth extended conductor 44 electrically connected to an end of the second coil 22 are disposed so as not to overlap the first coil 21 in plan view. On the other hand, the second coil conductor layer 52 of the second coil 22 is disposed overlapping with the first extended conductor 41 and the second extended conductor 42 in plan view.

According to the first coil 21 and the second coil 22, the second coil 22 can be disposed above the first coil 21 without providing the avoidance unit, and thus, the production of the multilayer coil can be simplified.

### Second Embodiment of Multilayer Coil

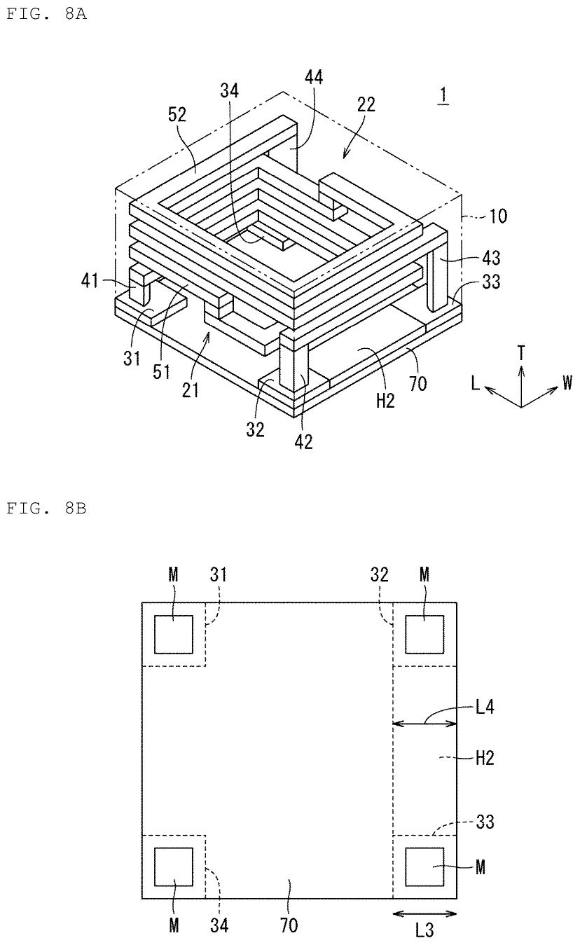

Next, a multilayer coil of a second embodiment will be described with reference to FIGS. 8A, 8B, and 9. FIG. 8A is a perspective view (top view) schematically illustrating an example of an internal structure of the multilayer coil of the second embodiment, FIG. 8B is a perspective view (bottom view) schematically illustrating an example of the internal structure of the multilayer coil of the second embodiment, and FIG. 9 is an exploded perspective view of a part of the internal structure of the multilayer coil of the second embodiment. The multilayer coil of the second embodiment is different from the multilayer coil of the first embodiment and the modification of the first embodiment described above in that an insulating layer 70 is further provided on the first main surface 11 of the body 10, and the second external electrode 32 and the third external electrode 33 are directly connected without using the conductor wiring described in the first embodiment. In the following description, differences from the multilayer coil described in the above-described embodiment will be mainly described.

### -Body-

In the present embodiment, the magnetic layer groups G1 to G8 illustrated in FIG. 5 are laminated, and the magnetic layer group G9 and the magnetic layer group G10 illustrated in FIG. 9 are laminated on the bottom surface side of the magnetic layer group G8.

The magnetic layer group G9 includes two magnetic layers S as an example. The magnetic layer S is provided with the first extended conductor 41, the second extended conductor 42, the third extended conductor 43, and the fourth extended conductor 44 at corner portions.

The magnetic layer group G10 includes two magnetic layers S as an example. The magnetic layer S is provided with the first external electrode 31 and the fourth external electrode 34, and an electrode wiring H2 for directly connecting the second external electrode 32 and the third external electrode 33.

### -Insulating Layer-

The insulating layer 70 is a layer laminated on the first main surface 11 of the body 10 (see FIGS. 1 and 9), and examples thereof include a photoresist. The insulating layer 70 is provided with openings at positions facing the first external electrode 31, the second external electrode 32, the third external electrode 33, and the fourth external electrode 34. Each opening is filled with a conductive member M electrically connected to the external electrodes.

As the conductive member M, for example, one or more plating materials selected from Ni, Sn, Cu, and Au may be used in consideration of joinability to the mounting board.

As a preferable aspect of the present embodiment, the plane area of the conductive member Mis preferably different from the plane area of the external electrodes 31 to 34. With this configuration, the plane area of the conductive member M can be designed corresponding to the size of the electrodes of the mounting board when the size of the electrodes of the mounting board is different from the size of the external electrodes. More preferably, the plane area of the conductive member M is smaller than the plane area of the external electrodes 31 to 34. With this configuration, the position of the conductive member M can be correctly aligned by the insulating layer when the position of the external electrodes is displaced because of compression, firing, or the like of the body.

### -External Electrode-

In the multilayer coil of the present embodiment, the second external electrode 32 and the third external electrode 33 are electrically connected by the electrode wiring H2 directly connecting the second external electrode 32 and the third external electrode 33 without using the conductor wiring directly connecting the second extended conductor 42 and the third extended conductor 43.

In the electrode wiring H2, a width dimension L4 orthogonal to the direction in which the second external electrode 32 is directed toward the third external electrode 33 is preferably about the same as a width dimension L3 of the second external electrode 32 and the width dimension L3 of the third external electrode (see FIG. 8B).

When the second external electrode 32 and the third external electrode 33 are electrically connected by the electrode wiring H2 directly connecting the second external electrode 32 and the third external electrode 33 as in the multilayer coil of the second embodiment, it is possible to reduce a situation in which the insulation resistance between the coils decreases by preventing a short circuit of the coils in the body 10 caused by a generation of an unexpected voltage in the multilayer coil. Thus, degradation of the electrical characteristics of the inductor can be reduced.

### Third Embodiment of Multilayer Coil

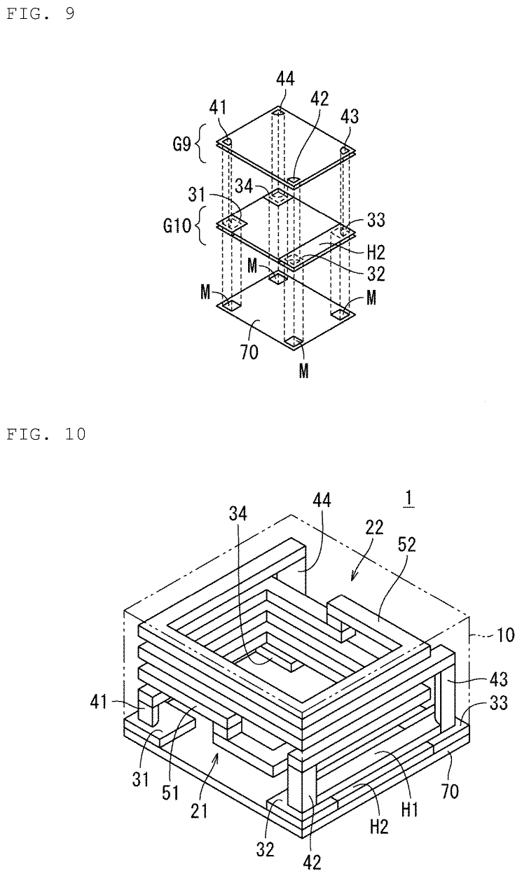

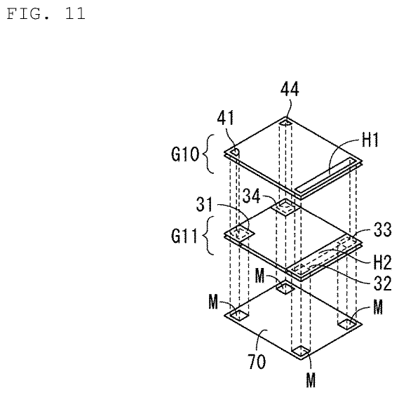

Next, a multilayer coil of a third embodiment will be described with reference to FIGS. 10 and 11. FIG. 10 is a perspective view (top view) schematically illustrating an example of an internal structure of the multilayer coil of the third embodiment, and FIG. 11 is an exploded perspective view of a part of the internal structure of the multilayer coil of the third embodiment. The multilayer coil of the third embodiment is different from the multilayer coil of the above-described embodiments in that the multilayer coil includes a conductor wiring directly connecting the second extended conductor and the third extended conductor and an electrode wiring directly connecting the second external electrode and the third external electrode. In the following description, differences from the multilayer coil described in the above-described embodiments will be mainly described.

### -Body-

In the present embodiment, the magnetic layer groups G1 to G9 illustrated in FIG. 5 are laminated, and the magnetic layer group G10 and the magnetic layer group G11 illustrated in FIG. 11 are laminated on the bottom surface side of the magnetic layer group G9.

The magnetic layer group G10 includes two magnetic layers S as an example. The magnetic layer S is provided with the first extended conductor 41 and the fourth extended conductor 44, and a conductor wiring H1 for directly connecting the second external electrode 32 and the third external electrode 33.

The magnetic layer group G11 includes two magnetic layers S as an example. The magnetic layer S is provided with the first external electrode 31 and the fourth external electrode 34, and an electrode wiring H2 for directly connecting the second external electrode 32 and the third external electrode 33.

An insulating layer 70 is provided below the magnetic layer group G11. The insulating layer 70 is as described in the second embodiment.

The multilayer coil of the present embodiment includes the conductor wiring H1 directly connecting the second extended conductor 42 and the third extended conductor 43, and the electrode wiring H2 directly connecting the second external electrode 32 and the third external electrode 33. By using both the conductor wiring H1 and the electrode wiring H2 in this manner, the second external electrode 32 and the third external electrode 33 can be electrically connected with lower resistance, and it is possible to reduce degradation of the electrical characteristics of the inductor by preventing a short circuit of the coils provided in the body 10 caused by a generation of unexpected voltage in the multilayer coils.

As a preferable aspect of the present embodiment, the width dimension of the conductor wiring H1 connecting the second extended conductor 42 and the third extended conductor 43 may be smaller than the width dimension of the electrode wiring connecting the second external electrode 32 and the third external electrode 33. In other words, the plane area of the conductor wiring H1 in plan view may be smaller than the plane area of the electrode wiring H2. By making the width dimension (or plane area) of the conductor wiring H1 relatively small, the reduction amount of the volume of the magnetic grains in the magnetic layer S in plan view can be reduced. Thus, the influence on the inductance value can be reduced.

### Description of Multilayer Coil Array

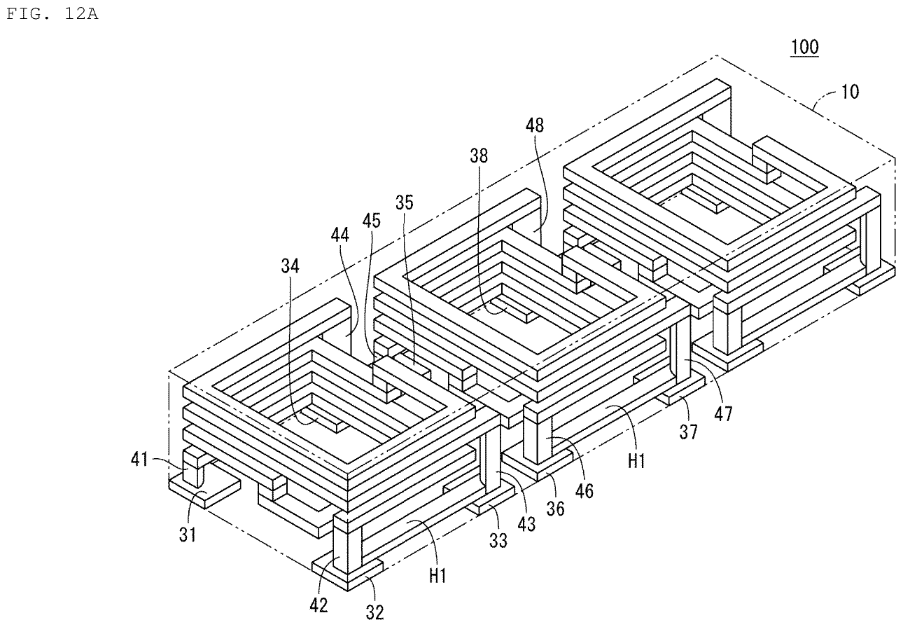

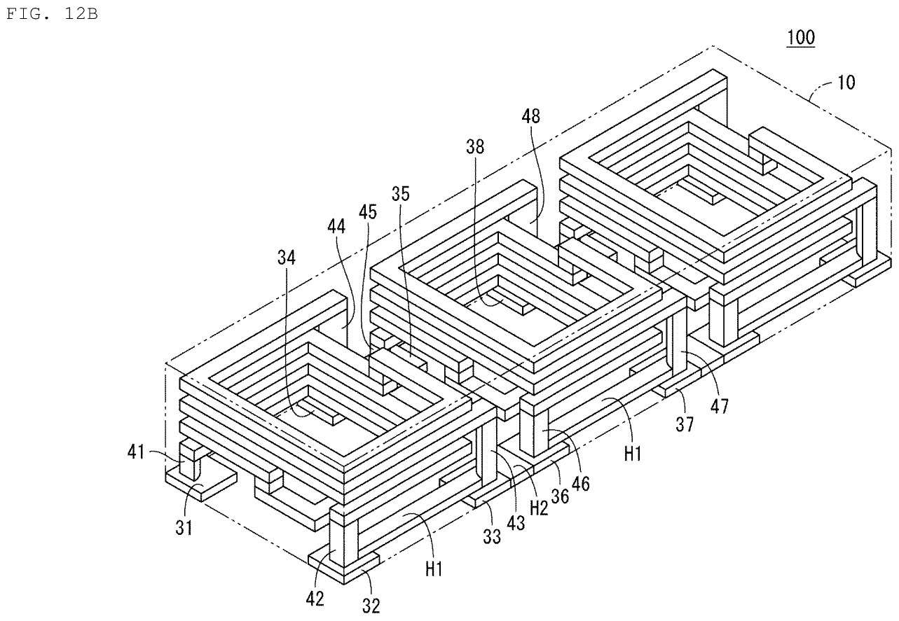

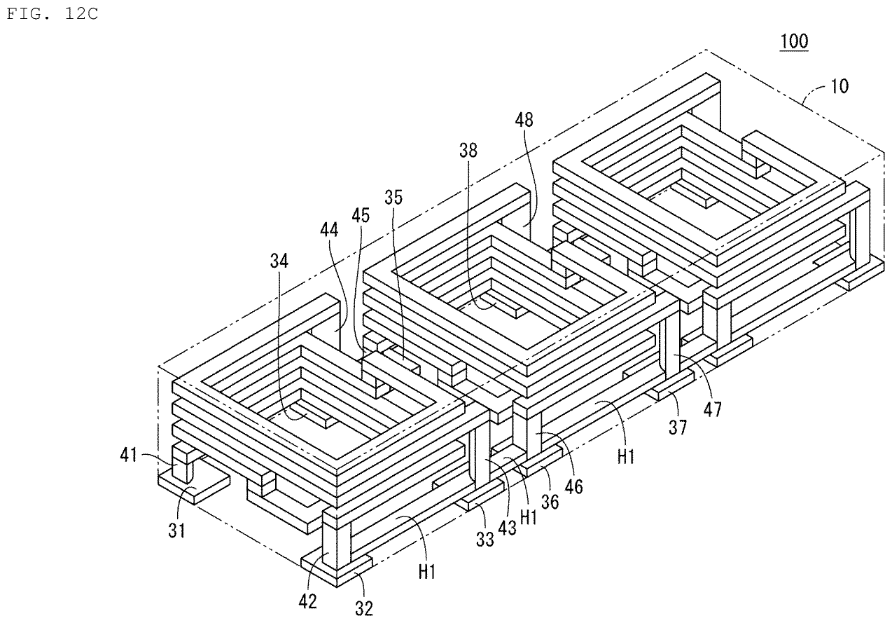

Next, a multilayer coil array of the present disclosure will be described with reference to FIGS. 12A to 12C. FIGS. 12A, 12B, and 12C are perspective views each schematically illustrating an example of an internal structure of the multilayer coil array of the present disclosure.

The multilayer coil array 100 of the present disclosure may include a third coil and a fourth coil inside the body 10 in addition to the first coil 21 and the second coil 22 described above for the multilayer coil. The third coil has substantially the same structure as the first coil 21, and the fourth coil has substantially the same structure as the second coil 22. That is, the second coil is provided at a position farther from the bottom surface of the body 10 than the first coil in the lamination direction, and the fourth coil is provided at a position farther from the bottom surface of the body 10 than the third coil in the lamination direction. The third coil and the fourth coil are provided adjacent to the first coil 21 and the second coil 22. In other words, the third coil and the fourth coil are provided in a direction perpendicular to the lamination direction of the multilayer coils with respect to the first coil 21 and the second coil 22.

The multilayer coil array 100 of the present disclosure may include a fifth external electrode 35 and a sixth external electrode 36 electrically connected to the third coil. Among the ends of the third coil, an end of the third coil conductor layer closest to the bottom surface may be connected to the fifth external electrode 35 by a fifth extended conductor 45. The other end of the third coil conductor layer and the sixth external electrode 36 may be connected by a sixth extended conductor 46.

The multilayer coil array 100 of the present disclosure may include a seventh external electrode 37 and an eighth external electrode 38 electrically connected to the fourth coil. The fourth coil may be provided at a position farther from the bottom surface of the body 10 than the third coil in the lamination direction. Among the ends of the fourth coil, an end of the fourth coil conductor layer closest to the bottom surface may be connected to the seventh external electrode 37 by a seventh extended conductor 47. The other end of the fourth coil conductor layer and the eighth external electrode 38 are connected by an eighth extended conductor 48.

Here, as a characteristic configuration of the multilayer coil array 100 of the present disclosure, the second external electrode 32 and the third external electrode 33 may be electrically connected, and the sixth external electrode 36 and the seventh external electrode 37 may be electrically connected. For example, in the multilayer coil array illustrated in FIG. 12A, the second external electrode 32 and the third external electrode 33 are directly connected by the conductor wiring H1, and the sixth external electrode 36 and the seventh external electrode 37 are directly connected by the conductor wiring H1. Thus, a short circuit between the first coil 21 and the second coil 22 and/or the third coil and the fourth coil can be prevented.

In the multilayer coil array 100 illustrated in FIG. 12B as an example, the third external electrode 33 and the sixth external electrode 36 are directly connected to each other. In the illustrated example, the third external electrode 33 and the sixth external electrode 36 are directly connected by the electrode wiring H2. Such a configuration can prevent a short circuit between the first coil and the third coil (or the fourth coil) and between the second coil and the third coil (or the fourth coil) in addition to preventing a short circuit in the vicinity where the first coil 21 and the second coil 22 are closest to each other.

In the multilayer coil array 100 illustrated in FIG. 12C as an example, the third extended conductor 43 and the sixth extended conductor 46 are directly connected. In the illustrated example, the third extended conductor 43 and the sixth extended conductor 46 are directly connected by the conductor wiring H1. Such a configuration can prevent a short circuit between the first coil and the third coil (or the fourth coil) and the second coil and the third coil (or the fourth coil) in addition to preventing a short circuit between the first coil 21 and the second coil 22.

The multilayer coil arrays 100 illustrated in FIGS. 12A to 12C exemplify a configuration in which six coils are provided inside a body. The multilayer coil array of the present disclosure is not limited to this example, and it may be a multilayer coil array 100 in which four coils are provided inside one body, or a multilayer coil array 100 in which four or more coils are provided inside one body. By using the multilayer coil array 100 in which a plurality of coils are provided inside a body in this manner, the multilayer coil array can be used for large current applications, and the mounting area and/or the mounting cost can be reduced by arraying the multilayer coils.

The embodiments disclosed herein are illustrative in all respects, and do not provide a basis for restrictive interpretations. For example, the second extended conductor and the third external electrode may be connected. Thus, the technical scope of the present disclosure is not to be construed only by the above-described embodiments, but is defined based on the recitation of the claims. The technical scope of the present disclosure includes meanings equivalent to claims and all modifications within the scope. Aspects of the multilayer coil and the multilayer coil array of the present disclosure are as follows.
<1> A multilayer coil including a body in which a magnetic layer is laminated; a first coil including a plurality of first coil conductor layers in a lamination direction, and a second coil including a plurality of second coil conductor layers in the lamination direction, the first coil and the second coil being provided inside the body; a first external electrode electrically connected to the first coil and a second external electrode electrically connected to the first coil; and a third external electrode electrically connected to the second coil and a fourth external electrode electrically connected to the second coil. The first to fourth external electrodes are disposed on a bottom surface of the body. The second coil is provided at a position farther from the bottom surface of the body than the first coil is in the lamination direction. Also, the multilayer coil includes a first extended conductor provided inside the body and connecting an end of a first coil conductor layer closest to the bottom surface among the plurality of first coil conductor layers out of ends of the first coil and the first external electrode; a second extended conductor provided inside the body and connecting the other end of the first coil and the second external electrode; a third extended conductor provided inside the body and connecting an end of a second coil conductor layer closest to the bottom surface among the plurality of second coil conductor layers out of ends of the second coil and the third external electrode; and a fourth extended conductor provided inside the body and connecting the other end of the second coil and the fourth external electrode. The second external electrode and the third external electrode are electrically connected.
<2> The multilayer coil according to <1>, wherein the second extended conductor and the third extended conductor are directly connected by a conductor wiring.
<3> The multilayer coil according to <1> or <2>, wherein the second external electrode and the third external electrode are directly connected by an electrode wiring.
<4> The multilayer coil according to <1>, the multilayer coil including a conductor wiring directly connecting the second extended conductor and the third extended conductor; and an electrode wiring directly connecting the second external electrode and the third external electrode.
<5> The multilayer coil according to any one of <1> to <4>, wherein the conductor wiring connecting the second extended conductor and the third extended conductor has a width narrower than a width of the electrode wiring connecting the second external electrode and the third external electrode.
<6> A multilayer coil array including a body in which a magnetic layer is laminated; a first coil including a plurality of first coil conductor layers in a lamination direction, and a second coil including a plurality of second coil conductor layers in the lamination direction, a third coil including a plurality of third coil conductor layers in the lamination direction, and a fourth coil including a plurality of fourth coil conductor layers in the lamination direction, the first coil, the second coil, the third coil, and the fourth coil being provided inside the body. The multilayer coil array further includes a first external electrode electrically connected to the first coil and a second external electrode electrically connected to the first coil; a third external electrode electrically connected to the second coil and a fourth external electrode electrically connected to the second coil; a fifth external electrode electrically connected to the third coil and a sixth external electrode electrically connected to the third coil; and a seventh external electrode electrically connected to the fourth coil and an eighth external electrode electrically connected to the fourth coil. The first to eighth external electrodes are disposed on a bottom surface of the body, the second coil is provided at a position farther from the bottom surface of the body than the first coil is in the lamination direction, and the fourth coil is provided at a position farther from the bottom surface of the body than the third coil is in the lamination direction. Also, the multilayer coil includes a first extended conductor provided inside the body and connecting an end of a first coil conductor layer closest to the bottom surface among the plurality of first coil conductor layers out of ends of the first coil and the first external electrode; a second extended conductor provided inside the body and connecting the other end of the first coil and the second external electrode; a third extended conductor provided inside the body and connecting an end of a second coil conductor layer closest to the bottom surface among the plurality of second coil conductor layers out of ends of the second coil and the third external electrode; and a fourth extended conductor provided inside the body and connecting the other end of the second coil and the fourth external electrode. The multilayer coil further includes a fifth extended conductor provided inside the body and connecting an end of a third coil conductor layer closest to the bottom surface among the plurality of third coil conductor layers out of ends of the third coil and the fifth external electrode; a sixth extended conductor provided inside the body and connecting the other end of the third coil and the sixth external electrode; a seventh extended conductor provided inside the body and connecting an end of a fourth coil conductor layer closest to the bottom surface among the plurality of fourth coil conductor layers out of ends of the fourth coil and the seventh external electrode; and an eighth extended conductor provided inside the body and connecting the other end of the fourth coil and the eighth external electrode. The second external electrode and the third external electrode are electrically connected, and the sixth external electrode and the seventh external electrode are electrically connected.
<7> The multilayer coil array according to <6>, wherein the third external electrode and the sixth external electrode are directly connected.
<8> The multilayer coil array according to <6> or <7>, wherein the third extended conductor and the third extended conductor are directly connected.

The multilayer coil and the multilayer coil array of the present disclosure can be suitably used as an electronic component capable of reducing degradation of electrical characteristics.

What is claimed is:

1. A multilayer coil comprising:
a body in which a magnetic layer is laminated;
a first coil including a plurality of first coil conductor layers in a lamination direction, and a second coil including a plurality of second coil conductor layers in the lamination direction, the first coil and the second coil being inside the body;
a first external electrode electrically connected to the first coil and a second external electrode electrically connected to the first coil;
a third external electrode electrically connected to the second coil and a fourth external electrode electrically connected to the second coil,
wherein the first to fourth external electrodes are on a bottom surface of the body, and
the second coil is at a position farther from the bottom surface of the body than the first coil is in the lamination direction;
a first extended conductor inside the body and connecting the first external electrode and an end of a first coil conductor layer closest to the bottom surface among the plurality of the first coil conductor layers out of ends of the first coil;
a second extended conductor inside the body and connecting the other end of the first coil and the second external electrode;
a third extended conductor inside the body and connecting the third external electrode and an end of a second coil conductor layer closest to the bottom surface among the plurality of the second coil conductor layers out of ends of the second coil; and
a fourth extended conductor inside the body and connecting the other end of the second coil and the fourth external electrode, and
wherein the second external electrode and the third external electrode are electrically connected.

2. The multilayer coil according to claim 1, wherein
the second extended conductor and the third extended conductor are directly connected by a conductor wiring.

3. The multilayer coil according to claim 1, wherein
the second external electrode and the third external electrode are directly connected by an electrode wiring.

4. The multilayer coil according to claim 1, the multilayer coil comprising:
a conductor wiring directly connecting the second extended conductor and the third extended conductor; and
an electrode wiring directly connecting the second external electrode and the third external electrode.

5. The multilayer coil according to claim 4, wherein
a width of the conductor wiring connecting the second extended conductor and the third extended conductor is narrower than a width of the electrode wiring connecting the second external electrode and the third external electrode.

6. The multilayer coil according to claim 2, wherein
the second external electrode and the third external electrode are directly connected by an electrode wiring.

7. A multilayer coil array comprising:
a body in which a magnetic layer is laminated;
a first coil including a plurality of first coil conductor layers in a lamination direction, and a second coil including a plurality of second coil conductor layers in the lamination direction, a third coil including a plurality of third coil conductor layers in the lamination direction, and a fourth coil including a plurality of fourth coil conductor layers in the lamination direction, the first coil, the second coil, the third coil, and the fourth coil being inside the body;
a first external electrode electrically connected to the first coil and a second external electrode electrically connected to the first coil;
a third external electrode electrically connected to the second coil and a fourth external electrode electrically connected to the second coil;
a fifth external electrode electrically connected to the third coil and a sixth external electrode electrically connected to the third coil; and
a seventh external electrode electrically connected to the fourth coil and an eighth external electrode electrically connected to the fourth coil,
wherein
the first to eighth external electrodes are on a bottom surface of the body,
the second coil is at a position farther from the bottom surface of the body than the first coil is in the lamination direction, and
the fourth coil is at a position farther from the bottom surface of the body than the third coil is in the lamination direction;
a first extended conductor inside the body and connecting the first external electrode and an end of a first coil conductor layer closest to the bottom surface among the plurality of first coil conductor layers out of ends of the first coil;
a second extended conductor inside the body and connecting the other end of the first coil and the second external electrode;
a third extended conductor inside the body and connecting the third external electrode and an end of a second coil conductor layer closest to the bottom surface among the plurality of second coil conductor layers out of ends of the second coil;
a fourth extended conductor inside the body and connecting the other end of the second coil and the fourth external electrode;
a fifth extended conductor inside the body and connecting the fifth external electrode and an end of a third coil conductor layer closest to the bottom surface among the plurality of third coil conductor layers out of ends of the third coil;
a sixth extended conductor inside the body and connecting the other end of the third coil and the sixth external electrode;
a seventh extended conductor inside the body and connecting the seventh external electrode and an end of a fourth coil conductor layer closest to the bottom surface among the plurality of fourth coil conductor layers out of ends of the fourth coil; and
an eighth extended conductor inside the body and connecting the other end of the fourth coil and the eighth external electrode,
wherein
the second external electrode and the third external electrode are electrically connected, and
the sixth external electrode and the seventh external electrode are electrically connected.

8. The multilayer coil array according to claim 7, wherein
the third external electrode and the sixth external electrode are directly connected.

9. The multilayer coil array according to claim 7, wherein
the third extended conductor and the sixth extended conductor are directly connected.

10. The multilayer coil array according to claim 8, wherein
the third extended conductor and the sixth extended conductor are directly connected.
